(19) United States
(12) Patent Application Publication
(10) Pub. No.: US 2006/0086149 A1
(43) Pub. Date: Apr. 27, 2006

(54) Apparatus for manufacturing photonic crystal fiber preform

(75) Inventors: Soon-Jae Kim, Gumi-si (KR); Keun-Deok Park, Sasang-gu (KR); Jin-Han Kim, Gumi-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/216,865

(22) Filed: Aug. 31, 2005

(30) Foreign Application Priority Data
Oct. 22, 2004 (KR) 2004-84789

(51) Int. Cl. C03B 37/075; C03B 37/016

(52) U.S. Cl. 65/393; 65/395

(57) ABSTRACT

An apparatus for manufacturing a photonic crystal fiber preform having a plurality of holes that extend in a lengthwise direction of the photonic crystal fiber perform is disclosed. The apparatus includes a housing for receiving a raw material for the photonic crystal fiber perform, a first support section arranged at an upper part of the housing; a second support section arranged at a lower part of the housing, and a plurality of pins supported by the first and second support sections. At least a portion of each pin is positioned in the housing. The apparatus also includes a vacuum pump for vacuumizing the interior of the housing; a first pipe connected to the lower part of the housing to introduce the raw material into the housing; and a first valve installed on the first pipe to open and close the first pipe.

### CLAIM OF PRIORITY

This application claims priority to an application entitled “An apparatus for manufacturing a photonic crystal fiber preform,” filed in the Korean Intellectual Property Office on Oct. 22, 2004 and assigned Serial No. 2004-84789, the contents of which are hereby incorporated by reference.

### BACKGROUND OF THE INVENTION

1. Field of the Invention

The present invention relates to a photonic crystal fiber (PCF) and, more particularly, to an apparatus for manufacturing a photonic crystal fiber preform.

2. Description of the Related Art

A photonic crystal fiber is made of a transparent glass material. It has a plurality of holes that extend in a lengthwise direction of the photonic crystal fiber. Propagation of an optical signal in the photonic crystal fiber is possible by a photonic band gap effect and an effective refraction index. For additional background information, see T. A. Birks et. al., Electronic letters, Vol. 31 (22), p. 1941 (October, 1995), and J. C. Knight et. al., Proceeding of OFC, PD 3-1 (February, 1996).

There are several methods for manufacturing a photonic crystal fiber perform—e.g., a glass stacking method, a glass drilling method, and a sol-gel method.

In the glass stacking method, a plurality of glass tubes are stacked into a desired shape, bound and elongated. This is repeated a multitude of times to manufacture a photonic crystal fiber preform.

In the glass drilling method, a plurality of holes are defined through a glass rod by drilling.

In the sol-gel method, a hollow cylinder-shaped mold with a plurality of pins is used. Liquid sol is poured into the mold so that the sol can freely drop into the mold. After the sol has gelled, the gel is removed from the mold. Thereupon, by implementing drying, low-temperature heat-treating, and sintering processes for the gel, a photonic crystal fiber preform is obtained. Characteristics of a photonic crystal fiber that is obtained by melting the photonic crystal fiber preform are determined depending upon the size of a core, the diameter of a hole, and the air filling factor (AFF) that represents the ratio of the distance between the centers of adjoining holes (a pitch) with the diameter of the hole.

As described above, in the conventional sol-gel method for manufacturing a photonic crystal fiber preform, the sol freely drops from the top of the mold into the mold. Due to this fact, however, bubbles may be captured in the sol because they are not discharged to the outside in the course of gelling of the sol. Therefore, the gel manufactured in this way still contains the bubbles even after implementing a heat treatment process. Consequently, since the photonic crystal fiber preform contains the bubbles, it suffers from optical loss and deteriorated optical characteristics.

### SUMMARY OF THE INVENTION

One aspect of the present invention relates to an apparatus for manufacturing a photonic crystal fiber preform that can minimize bubble generation in a sol-filling procedure.

One embodiment of the present invention is directed to an apparatus for manufacturing a photonic crystal fiber preform having a plurality of holes that extend in a lengthwise direction of the photonic crystal fiber perform. The apparatus includes a housing for receiving a raw material for the photonic crystal fiber perform, a first support section arranged at an upper part of the housing; a second support section arranged at a lower part of the housing, a plurality of pins supported by the first and second support sections so that at least a portion of each pin is positioned in the housing; a vacuum pump for vacuumizing an interior of the housing; a first pipe connected to the lower part of the housing to introduce the raw material into the housing, and a first valve installed on the first pipe to open and close the first pipe.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a view illustrating a photonic crystal fiber preform according to one embodiment of the present invention;

FIG. 2 is a view illustrating an apparatus for manufacturing a photonic crystal fiber preform in accordance with an embodiment of the present invention; and

FIG. 3 is a planar view illustrating the apparatus shown in FIG. 2, with pins removed.

### DETAILED DESCRIPTION

Hereinafter, embodiments of the present invention will be described with reference to the accompanying drawings. In the following description of the present invention, a detailed description of known functions and configurations incorporated herein will be omitted when it may obscure the subject matter of the present invention.

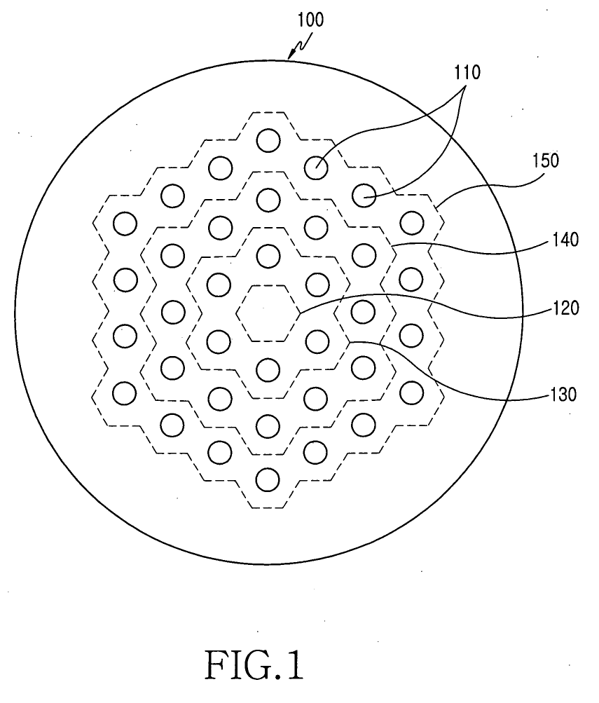

FIG. 1 is a view illustrating a photonic crystal fiber preform 100 according to one embodiment of present invention. The photonic crystal fiber preform 100 possesses a circular rod-shaped configuration, is made of glass, and has a plurality of circular holes 110 that extend in a lengthwise direction of the photonic crystal fiber preform 100. The holes 110 are arranged around a core region 120, which is formed at a center portion of the photonic crystal fiber preform 100, to define a plurality of layers.

In this embodiment, the holes 110 are arranged around the core region 120 to define three layers each of which has a regular hexagonal structure. A first layer 130 which surrounds the core region 120 includes six holes 110, a second layer 140, which surrounds the first layer, includes twelve holes 110, and a third layer 150, which surrounds the second layer 140, includes eighteen holes 110. The number of holes in each layer and the number of layers can be changed as occasion demands. Each layer can also have different structures as occasion demands, e.g., a quadrangular structure.

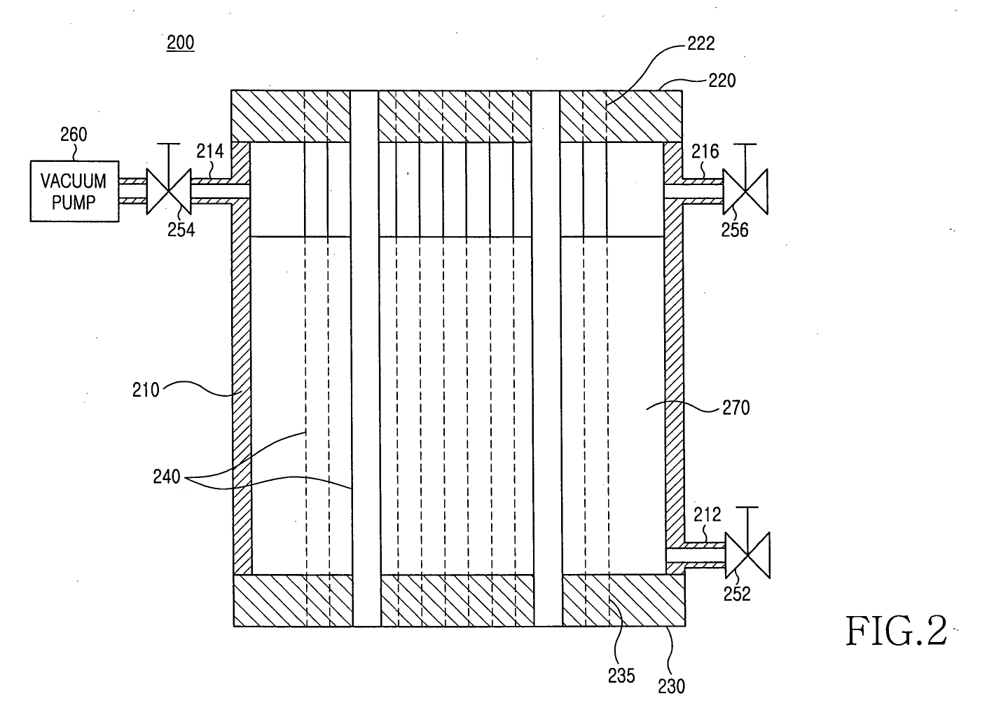

FIG. 2 is a view illustrating an apparatus for manufacturing a photonic crystal fiber preform in accordance with an embodiment of the present invention. The apparatus 200 serves as a molding apparatus that is used in a sol-gel procedure. The apparatus 200 includes a housing 210, first and second support sections 220 and 230, a plurality of pins 240, a vacuum pump 260, first through third pipes 212, 214 and 216, and first through third valves 252, 254 and 256.

When viewed in its entirety, the housing 210 has the shape of a circular tube that is opened at both ends thereof. The housing 210 can receive sol 270 which is a raw material for the photonic crystal fiber preform 100. The housing 210 has the first pipe 212 at its lower part and the second and third pipes 214 and 216 at its upper part. The first through the third pipes 212, 214 and 216 communicate with the interior of the housing 210 at their opened ends, and may have a circular or other sectional shapes. The sol 270 is introduced into the housing 210 through the first pipe 212 to fill the housing 210 from bottom to top. Due to the fact that the first pipe 212 is positioned at the lower part of the housing 210, bubble generation when introducing the sol 270 into the housing 210 can be minimized.

The first valve 252 is installed on the first pipe 212 to open and close the first pipe 212.

The first support section 220 is positioned at the upper part of the housing 210, which is opened. The first support section 220 has a shape of a disc that is defined with a plurality of circular holes 222. The first support section 220 closes the opened upper end of the housing 210. The holes 222 of the first support section 220 are arranged in the same manner as the holes 110 shown in FIG. 1.

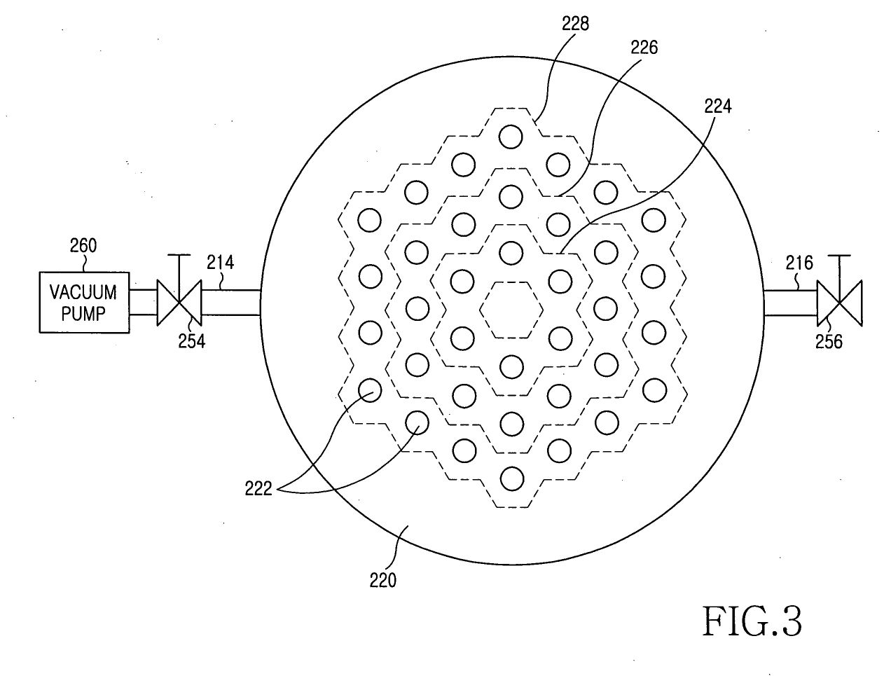

FIG. 3 is a planar view illustrating the apparatus 200 with the pins 240 removed. As shown in FIG. 3, the first support section 210 has the plurality of holes 222. The holes 222 are arranged around a core region, which is formed at the center portion of the first support section 210, to define a plurality of layers 224, 226 and 228.

In this embodiment, the holes 222 are arranged around the core region to define three layers each of which has a regular hexagonal structure. The first layer 224, which surrounds the core region, includes six holes 222, the second layer 226, which surrounds the first layer 224, includes twelve holes 222, and the third layer 228, which surrounds the second layer 226, includes eighteen holes 222.

Referring again to FIG. 2, the second support section 230 is positioned at the lower part of the housing 210, which is opened. The second support section 230 has a shape of a disc that is defined with a plurality of circular holes 235. The second support section 230 has the same shape as the first support section 220, and the holes 235 of the second support section 230 are respectively aligned with the corresponding holes 222 of the first support section 220. Due to the fact that the second support section 230 closes the opened lower end of the housing 210, the sol 270 introduced into the housing 210 through the first pipe 212 is held in the housing 210 as shown in the drawing.

The plurality of pins 240 has a circular rod-shaped configuration. Both ends of each pin 240 are respectively fitted into a pair of holes of the first and second support sections 220 and 230, which are aligned with each other. In order to allow the gel to be easily removed from the housing 210, the upper end of each pin 240 is fixed to a circumferential inner surface of the corresponding hole 222 of the first support section 220, and the lower end of each pin 240 is removably inserted into the corresponding hole 235 of the second support section 230. Of course, it can be envisaged that the lower end of each pin 240 is fixed to a circumferential inner surface of the corresponding hole 235 of the second support section 230, and the upper end of each pin 240 is removably inserted into the corresponding hole 222 of the first support section 220. As in the case of the first and second support sections 220 and 230, the pins 240 are arranged around the core region to define three layers each of which has a regular hexagonal structure. A first layer, which surrounds the core region, includes six pins 240, a second layer, which surrounds the first layer, includes twelve pins 240, and a third layer, which surrounds the second layer, includes eighteen pins 240. When the pins 240 are installed on the housing 210, it is possible to obtain gel that has the plurality of holes each having a predetermined diameter. The gel has the same configuration as the photonic crystal fiber preform 100 shown in FIG. 1. By implementing drying, low-temperature heat-treating, and sintering processes for the gel, the photonic crystal fiber preform 100 as shown in FIG. 1 is obtained.

The vacuum pump 260 is connected to the other end of the second pipe 214 and functions to regulate pressure in the housing 210. Conventional vacuum pumps can be used for the vacuum pump 260. Conventional vacuum pumps are divided depending upon the vacuumizing level into a low vacuum pump having a vacuum range of 760 torr to 1×10⁻³ torr, a high vacuum pump having a vacuum range of 1×10⁻³ torr to 1×10⁻⁸ torr, and an ultr-high vacuum pump having a vacuum range of less than 1×10⁻⁸ torr.

As the low vacuum pump, a rotary pump can be employed. In such pumps, air tightness and lubrication of a suction chamber are maintained by oil. Fluid is discharged to the outside of the pump through rotation of component parts. An oil diffusion pump, which serves as a high vacuum pump, does not operate in the conventional atmospheric condition. The oil diffusion pump starts to operate at 10⁻³ torr after most of the air is discharged using another pump such as the rotary pump. If gas pressure is high, since a phenomenon may occur in which oil molecules crush with gas molecules several times to be stopped in their motion, a pressure at an inlet port must be lower than 10⁻³ torr. As the ultra-high vacuum pump, a titanium sublimation pump, an ion pump, a non-evaporable pump, etc., can be employed. Since the vacuum pump employed does not require a high vacuum level, it is sufficient to use the rotary pump as the low vacuum pump.

The second valve 254 is installed on the second pipe 214 and functions to open and close the second pipe 214.

The third valve 256 is installed on the third pipe 216 and functions to open and close the third pipe 216 so that the interior of the housing 210 can or cannot communicate with the atmosphere. When the third valve 256 is opened, an internal pressure of the housing 210 is the same as the atmospheric pressure.

Now a gel forming and removing procedure using the apparatus 200 will be described.

First, with the pins 240 installed on the housing 210, the first and third valves 252 and 256 are closed and the second valve 254 is opened.

Second, the vacuum pump 260 is actuated to vacuumize the interior of the housing 210. As the interior of the housing 210 reaches a predetermined vacuum level, the second valve 254 is closed and operation of the vacuum pump 260 is interrupted.

Third, the first valve 252 is opened and the sol 270 is introduced into the housing 210 through the first pipe 212 so that the sol 270 fills the housing 210 from bottom up to a predetermined height.

Fourth, in a state in which the introduction of the sol 270 is completed, the first valve 252 is closed. Then, the third valve 256 is opened to allow the internal pressure of the housing 210 to correspond to the atmospheric pressure.

Fifth, when the sol 270 has completely gelled, the pins 240 are removed.

Sixth, by raising the housing 210, the gel is separated from the housing 210.

Thereafter, by implementing drying, low-temperature heat-treating, and sintering processes for the gel, the photonic crystal fiber preform 100 as shown in FIG. 1 is obtained.

As is apparent from the above description, in the apparatus 200 for manufacturing a photonic crystal fiber preform a first pipe is positioned at a lower part of a housing so that bubble generation can be minimized in a sol-filling procedure.

Also, the apparatus 200 has an the interior of the housing that is maintained in a vacuumized state in the procedure of filling sol into the housing, which suppresses contact between the sol and air, so that bubble generation can be minimized.

While the invention has been shown and described with reference to certain embodiments thereof, it will be understood by those skilled in the art that various changes in form and details may be made therein without departing from the spirit and scope of the invention as defined by the appended claims.

What is claimed is:

1. An apparatus for manufacturing a photonic crystal fiber preform having a plurality of holes that extend in a lengthwise direction of the photonic crystal fiber preform, comprising:
a housing having an upper and a lower part;
a first support section arranged at the upper part of the housing;
a second support section arranged at the lower part of the housing;
a plurality of pins supported by the first and second support sections so that at least a portion of each pin is positioned in the housing;
a vacuum pump for vacuumizing an interior of the housing;
a first pipe connected to the lower part of the housing to introduce a raw material into the housing; and
a first valve installed on the first pipe to open and close the first pipe.

2. The apparatus according to claim 1, further comprising:
a second pipe for connecting the upper part of the housing with the vacuum pump; and
a second valve installed on the second pipe to open and close the second pipe.

3. The apparatus according to claim 1, further comprising:
a third pipe connected to the upper part of the housing; and
a third valve installed on the third pipe to open and close the third pipe so that the interior of the housing can or cannot communicate with atmosphere.

4. A fiber preform manufacturing apparatus, comprising:
a housing having an upper and a lower part;
at least one support section coupled to the housing;
a plurality of pins supported by the at least one support section so that at least a portion of each pin is positioned in the housing;
a first interface connected to the lower part of the housing to introduce a raw material into the housing; and
a first valve coupled to the first interface.

5. The apparatus according to claim 4, further comprising a vacuum pump for vacuumizing an interior of the housing;

6. The apparatus according to claim 5, further comprising:
a second interface for connecting the upper part of the housing with the vacuum pump; and
a second valve coupled to the second interface.

7. The apparatus according to claim 4, further comprising:
a third interface connected to the upper part of the housing; and
a third valve coupled to the third interface to open and close the third interface so that the interior of the housing can or cannot communicate with atmosphere.

8. A method for manufacturing a photonic crystal fiber preform having a plurality of holes that extend in a lengthwise direction of the photonic crystal fiber preform, the method comprising the steps of:
vacuumizing an interior of a housing to a predetermined vacuum level;
introducing liquid sol into the housing so that the sol fills the housing from bottom up to a predetermined height;
allowing an internal pressure of the housing to correspond to the atmospheric pressure;
allowing the sol to completely gel; and
separating the housing from the gelled sol.
